(19) United States
(12) Patent Application Publication
(10) Pub. No.: US 2002/0093882 A1
(43) Pub. Date: Jul. 18, 2002

(54) Multi player digital game clock

(76) Inventor: Seth Daniel Garlock, Bayville, NY (US)

Correspondence Address: Ward & Olivo, Suite 300, 382 Springfield Avenue, Summit, NJ, 07901, US

(21) Appl. No.: 10/027,811

(22) Filed: Dec. 20, 2001

Related U.S. Application Data
(63) Continuation of application No. 09/538,749, filed on Mar. 30, 2000.
(60) Provisional application No. 60/126,807, filed on Mar. 30, 1999.

(51) Int. Cl. G04F 3/00

(52) U.S. Cl. 368/96

(57) ABSTRACT

A digital game clock is disclosed. The clock can be used for timing multiple players and facilities standard game timing and custom game timing. The clock utilizes a solid housing with electronic control and digital displays. The electronic control provided an audible alarm, exact timing control and also facilities easy time setting. The digital displays show time, player indicators and other values. Additionally, faceplate over the digital display and a nonskid base increase durability of the game clock.

### FIELD OF THE INVENTION

The present invention relates to game clocks for timing multiple players. More particularly, the present invention relates to clocks which facilitate standard game timing and custom game timing.

### BACKGROUND OF THE INVENTION

Mechanical game clocks, designed primarily for chess, use traditional clock mechanisms in pairs to achieve a dual timer system. These mechanical game clocks are limited by the durability and reliability of their mechanisms. In the past, a variety of timing mechanisms have been used for game clocks, including but not limited to clock mechanisms, hourglasses, stopwatch mechanisms, and alarm clocks. In addition, with respect to mechanical game clocks, it is tougher for the user to read the necessary info (i.e. time left, etc.). Available models of mechanical chess clocks are prone to failure, due to wear during play, environment and misuse. Most mechanical chess clocks use two mainsprings, one for each player and the timing is not precise in relation to each other or in relation to a connected digital clock. Hybrid designs using separate digital clocks have been made. Mechanical chess clock designs with a move counter have also been made, but again, are subject to the limitations and problems with mechanical clocks. Digital game clocks are available using electronics to control a variety of display and timer functions. The timer functions are largely derived from traditional mechanical designs. Digital game clocks may include the ability to count moves during a game and apply timing controls automatically during play.

However, existing digital game clock designs are complex, some having manuals of up to sixty pages, and are housed in metal or plastic cases, making them easy to break, even with normal use. The complexity of the designs may make them difficult to use and set. In order to set an existing model, a player is required to perform seven separate functions (or button pushes). Due to the variety of games which require timing, the methods of game timing and types of tournament play, great number variations exist for the use of an easily settable game clock. Thus, there exists a need for a simple and highly functional multiplayer digital game clock that is more durable and easier to use and set than existing models.

Mounce et al. U.S. Pat. No. 3,877,216 discloses a digital countdown timer, including a digital countdown timer for timing warning periods. Although this invention exhibits a countdown function, it is not in the form of a game timing device.

Meshi et al. U.S. Pat. No. 4,062,180 discloses an electrical chess clock limited to three modes of operation (tournament mode, fast game mode and seconds game mode). Such a device has the following shortcomings. This invention lacks the capability to time multiple gaming events and is restricted to timing chess events. This invention also lacks the capability to display various play modes for operation. In addition, this invention fails to exhibit an easy mode of operation. Furthermore, this invention is not constructed of a solid rigid housing to avoid destruction.

Fischer U.S. Pat. No. 4,884,255 discloses a digital chess clock for timing dual chess events. Such a device fails to operate for other gaming events besides chess. Furthermore, this invention fails to disclose a device which is housed in a solid structure; therefore, it is susceptible to wear and tear.

Camaratta, Jr. et al. U.S. Pat. No. 5,420,830 discloses a chess clock with two standard clock faces. Such a device fails to incorporate a digital display. Furthermore, this invention is not applicable to multiple gaming events and is only useful for chess events.

Richardson et al. U.S. Pat. No. 4,472,067 discloses a chess clock. Such an invention has the shortcomings of exhibiting a high degree of difficulty in using such a device. Furthermore, this invention fails to apply to multiple gaming events besides chess.

### SUMMARY OF THE INVENTION

The present invention relates to a game clock for timing multiple player games. The present invention overcomes all of the problems systematically described in the prior art. The present invention allows setting of various time controls in a variety of games. These games include, but are not limited to, chess, go and backgammon. The preferred embodiment of the present invention discloses a novel game clock having a solid housing and electronic control, with a digital display for each player. The solid housing may be a solid material or heavy frame construction. The solid housing provides durability and finish quality. For example, in solid wood, the housing can be milled to receive the electronic assembly, player controls and a power device (i.e., batteries, AC adapter, etc.) . A variety of woods may be used for distinctive color and grain, as well as durability.

The digital displays may count up or count down in microseconds, seconds, minutes, hours, periods or other segments. The digital displays may display information other than time information, including but not limited to player selection, number of moves made, time remaining, time elapsed, which player is active, etc. The digital displays may also display iconic or graphic notation as required by the particular use, as well as indicate information not directly displayed.

The electronic control includes Player Control Buttons and Timer Control Buttons. The Player Control Buttons allow the individual players to activate the game timing. The Timer Control Buttons allow for setting and modifying the digital displays, control game selection and modification, as well as stopping and clearing of the digital displays. Timer Control Buttons display move count and other game settings and information.

The present invention can be set in hundreds of game situations with the performance of only three functions (i.e., button pushes), several fewer than other game clocks currently available. Of course, the number of “button pushes” required is dependent on the type of game being played. For example, one push activates the game clock (i.e., turns it on), a second push is needed to select a game preset, and a third push is required to press the preset button. This makes the present invention easier to use and mechanically preferable to other clocks currently available.

Various timing options have evolved to improve game quality and maintain tournament standards for particular games. Timing options may include, but are not limited to, microseconds, seconds, minutes or hours, time per move, time modification on move and time activation on move. Moreover, game options may include multiples, combinations, and any permutation of time options. An object of the present invention is to provide a game clock.

As a controller of time, and according to the preferred embodiment disclosed herein, the game clock will be able to count time at the limit of its oscillator speed. Time may be modified by button action or time condition. Time may be counted by unit (for example, seconds), or a period of multiple units (for example, five seconds).

The game clock has an audible signal, which may include spoken prompts. The sound capability may be modified and/or turned off. The game clock may be able to use an AC adapter, batteries or solar cells for power. The batteries used may be rechargeable, replaceable I 0 and/or backup.

Other objects, features and characteristics of the present invention, as well as the methods of operation and functions of the related elements of the structure, and the combination of parts and economies of manufacture, will become more apparent upon consideration of the following detailed description, with reference to the accompanying drawings, all of which form a part of this specification.

### BRIEF DESCRIPTION OF THE DRAWINGS

A further understanding of the present invention can be obtained by reference to a preferred embodiment set forth in the illustrations of the accompanying drawings. Although the illustrated embodiment is merely exemplary of systems for carrying out the present invention, both the organization and method of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention.

For a more complete understanding of the present invention, reference is now made to the following drawings:

FIG. 1 is a perspective view of a preferred embodiment of the digital game clock according to the present invention.

FIG. 2 shows a preferred embodiment of the electronic display assembly depicted IO generally in FIG. 1.

FIG. 3 is a flow chart showing a preferred embodiment of the button software of the digital game clock according to the present invention.

FIG. 4 is a flow chart showing a preferred embodiment of the timer software of the digital game clock according to the present invention.

FIG. 5 is a flow chart showing a preferred embodiment of the display software of the digital game clock according to the present invention.

FIG. 6 shows a Game Selection Table depicting certain preset timers which may be programmed into the digital game clock in accordance with the present invention.

### DETAILED DESCRIPTION AND PREFERRED EMBODIMENT

As required a detailed illustrative embodiment of the present invention is disclosed herein. However, techniques, systems and operating structures in accordance with the present invention may be embodied in a wide variety of sizes, shapes, forms and models, some of which may be quite different than those in the disclosed embodiment. Consequently, the specific structural and functional details disclosed herein are merely representative, yet in that regard, they are deemed to afford the best embodiment for purposes of disclosure and to provide a basis for the claims herein which define the scope of the present invention.

The following presents a detailed description of a preferred embodiment of the present invention, as well as some alternate embodiments of the invention. As discussed above, the present invention relates generally to game clocks for timing multiple players. Specifically, a digital game clock is provided having a housing and an electronic assembly with a multi-function display for each player. Reference is herein made to the figures, wherein the numerals representing particular parts are consistently used throughout the figures and accompanying discussion.

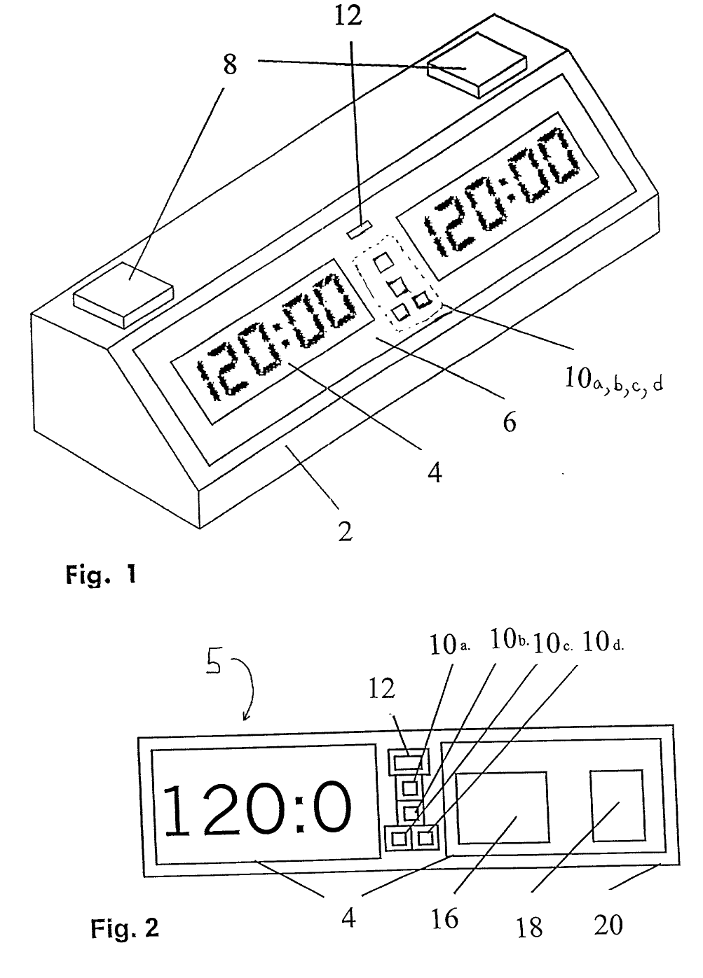

Referring first to FIG. 1, depicted is a perspective view of a preferred embodiment of the digital game clock according to the present invention. Each part is numbered and functionally explained below. Preferably, the digital game clock may comprise housing 2, electronic assembly 5, optional faceplate 6, player control buttons 8, timer control buttons 10a, 10b, 10c and 10d, and On/Off switch 12.

Housing 2 may be a solid material or may be a frame construction of materials such as wood, plastic, or metal, and would provide protection for the electronic components, durability of the overall timer, and optionally a decorative finish quality. The configuration of housing 2 depicted in FIG. 1 allows for easy viewing of the display screens 4 and easy access to player control buttons 8 (which are the main buttons accessed during play). If constructed of solid wood, plastic, or metal, the manufacture of housing 2 would preferably be by milling with cutaways to receive the various other components. Optionally, a variety of woods may be used for distinctive color and grain, or various types of plastics or metals allow for greater choice of finish.

In a preferred embodiment, housing 2 is solid wood, milled to receive the electronic assembly 5 (see FIG. 2) which includes display screens 4, timer control buttons 10a, 10b, 10c and 10d, and On/Off switch 12. Housing 2 receives on its top portion player control buttons 8. Preferably, display screens 4 are liquid crystal displays (LCDs), although other similar types of display screens may be used in accordance with this invention. Faceplate 6 covers and protects the electronic assembly 5, and is punched out (or has cutaway sections) for display screens 4, timer control buttons 10a, 10b, 10c and 10d and On/Off switch 12 of electronic assembly 5. Faceplate 6 may be attached to the housing 2 by any of a variety of attachment means, such as screws, VELCRO7, etc. Optionally, faceplate 6 may include names and/or icons for timer control buttons 10a, 10b, 10c and 10d and may include logos, registration markings, or other informative identifications. Also, faceplate 6 may be wood, metal or plastic and may have embossing or other distinctive and decorative markings. Housing 2 may optionally include a base attached to its bottom to provide a covering for a power source (e.g., batteries, transformer, AC/DC adapter(s), etc.) and may optionally include felt, rubber or other suitable plastic material on its bottom surface to prevent slippage or movement of housing, 2 during use.

Turning next to FIG. 2, shown is a layout of a preferred embodiment of the electronic assembly 5 of the digital game clock in accordance with the present invention. As depicted, the electronic assembly 5 comprises a pair of display screens 4 (which are preferably multifunction liquid crystal displays (LCDs)), liquid crystal display driver chip 16, timer control buttons 10a, 10b, 10c and 10d, microcontroller chip 18, and printed circuit board 20. Of course, it is envisioned that miscellaneous other support electronics, which are well known in the field of electronics and would be apparent to a person of skill in the art, may be used in accordance with the intended operation of the present invention. In one embodiment of electronic assembly 5 shown in FIG. 2, button 10a corresponds to a stop/clear button, button 10b corresponds to a preset/rest button, button 10c corresponds to a set A button and button 10d corresponds to a set B button. Also, microcontroller chip 18 contains preprogrammed microcode, which may be programmed to check player control buttons 8 and timer control buttons 10a, 10b, 10c and 10d, and then instruct display screens 4 to display the appropriate values.

Preferably, electronic assembly 5 is attached to player control buttons 8 via wires, for example, to sense their positions (i.e., ON or OFF). It is also preferable that player control buttons 8 be configured such that when one is ON, the other is OFF. In addition, electronic assembly 5 may be attached to a power source (i.e., battery holder or voltage transformer (not shown)), a buzzer or speaker (not shown), or some other audio/video device in order to provide power and audible or visual signals. In addition, electronic assembly 5 may be updated in both hardware and software to utilize the increasing power of electronics and accommodate the increasing complexity of games.

Regarding the function of the timer, various time options have evolved to improve game quality and maintain standards in competitive play such as tournaments. Time increments may include, but are not limited to, microseconds, seconds, minutes or hours. Timing options may include, but are not limited to, time per move, timer modification on move and timer activation on move. Game options may include multiples, combinations, and permutations of time options.

Display screens 4 may reflect the value of the player's timer. Player control buttons, 8 may set which players timer is active, while timer control buttons 10a, 10b, 10c and 10d may allow setting and modifying the timers. optionally, timer control buttons 10a, 10b, 10c and 10d may also control game selection and modification. Timer control button 10a may also control the stopping and clearing of display screens 4. Timer control buttons 10a, 10b, 10c and 10d may additionally control displaying the move count and other game settings and information.

A variety of games may be played with the digital game clock in accordance with the invention. The game timing options may include, but are not limited to, single period play, multiple period play, recurrent time play (seconds or gong), period play with recurrent time (Bronstein delay and Backgammon), period play with multiple recurrent time (Go with Byoyomi) or recurrent time with time allocation (Hourglass). Single period play may be a set number of microseconds, seconds, minutes or hours per player. In multiple period play, a time period may be followed by another time period, due to player action or timer condition. Multiple period play may be multiple single period plays.

Recurrent time play may be a set number of microseconds, seconds, minutes or hours per player. Recurrent time play (seconds or gong) may be caused by player action or timer condition. A recurrent time play may be used in addition to a single period play or multiple period play. A recurrent time play may be added to the timer (e.g., Fischer time) or may be used as a warning period (Bronstein Delay). Recurrent time play may be used in addition to a single period play or multiple period play after the period play is complete (Go with Byoyomi). Recurrent time play may be followed by other recurrent time plays (Go with Byoyomi).

The multi-player digital timer may count a number of microseconds, seconds, minutes or hours per player. As a controller of time, the digital game clock will be able to count time at the limit of its oscillator speed. Time may be modified by button action or pre-selected timer condition. Time may be counted by unit (i.e., seconds, minutes, etc.) or periods of multiple units (i.e., five seconds, five minutes, etc.) depending on the microcode programmed onto microcontroller chip 18.

Display screens 4 may count up or count down in microseconds, seconds, minutes, hours or periods. As a visual display, the digital game clock may be able to display to the limit of its graphic capability. The multi-function displays may display information other than timer information. Graphic displays may display player selection, moves made, time remaining, time used, player active, etc. Display screens 4 may have display annunciator, iconic, or other graphic notation as required. Display screens 4 may have functions marked but not directly displayed.

Alternatively, the digital game clock according to the invention may also include sound capability. That is, the digital game clock of the invention may be able to provide an audible signal to the limit of its sound capability. This sound capability may include alarms, sounds and/or speech, depending on the sound hardware and/or software incorporated into the digital game clock. Optionally, the sound capability may be modified and/or turned off.

In operation, the manual setting of the digital game clock according to the preferred embodiment of the invention requires a minimal number of steps (or button pushes). For example, to set both clocks to ten minutes each, turn the digital game clock on by pushing On/Off switch button 12 and then push or hold both set buttons 10c and 10d until display screens 4 show “[1 0:00 I 0:00]”. The game can then be started by pressing either of player control buttons 8, whereupon the respective time shown on display screens 4 will decrement, and for example, one second into the game, display screens 4 will read “[−9:59 10:00]”. At any time during a game, the digital game clock may be stopped by pressing the stop/clear button, timer control button 10a, once. To begin playing the game again, the user is merely required to press either of player start buttons 8.

Another feature of the digital game clock of the invention allows the user(s) to add or subtract time from either player. To add or subtract time to either players' timers, first stop the duel timer with timer control button 10a. Then, to subtract time from the timers, push or hold either set timer control button 10c or 10d and the preset/reset timer control button 10b. Pushing the set timer control buttons 10c and/or 10d alone increments the timers and pushing either set timer control buttons 10c and/or 10d with the preset/reset timer control button 10b decrements the timers.

To display the number of moves made (move count) while the game is in progress, push and hold either set button 10c or 10d. In one embodiment of the display of the present invention, the move count is the number shown in the minutes display “[08:45-09:45]”. When the set button is released, the display returns to normal minutes. By substituting the number of moves for the minutes in the display, the overall appearance of the display is simplified. of course, if a larger unit is acceptable, a separate display may be appropriate for the number of moves, and that number may be displayed at all times by default. In the present embodiment, the move count increments up to 99 moves and then begins to count up from zero again. Again, this is to preserve the limited space available on the display, and this can be reprogrammed if a larger display is acceptable.

Alternatively, the digital game clock may be adapted to use batteries or solar cells for power. The batteries used may be rechargeable, replaceable and/or backup. Additionally, a power transformer may be provided within the digital game clock to allow standard AC power as the power source.

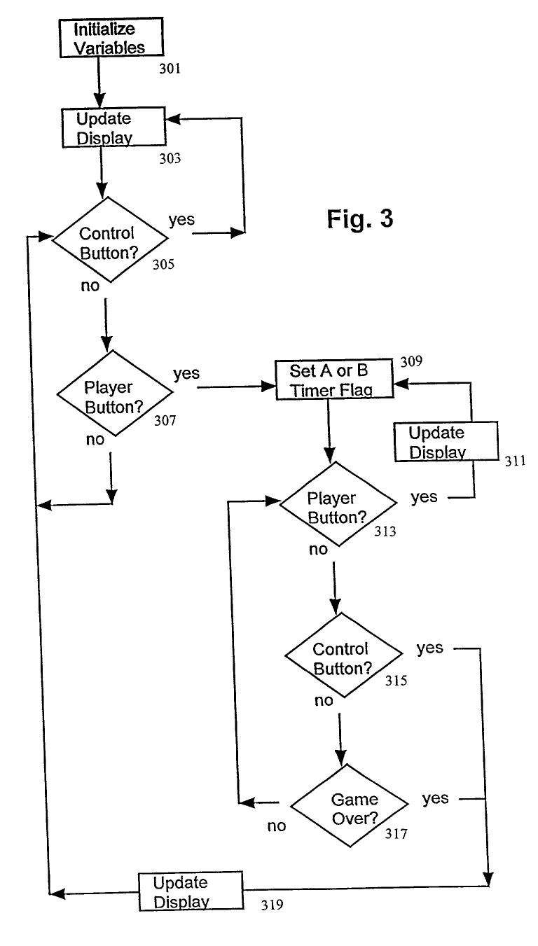

Referring now to FIG. 3, shown is a flow chart depicting a preferred embodiment of the player and timer control button software according to a preferred embodiment of the digital game clock. This flow chart may be a “top level loop”, controlling display screens 4 (see FIG. 2) with inputs from timer control buttons 10a, 10b, 10c and 10d (see FIGS. 1 and 2) and player control buttons 8 (see FIG. 1). As shown in FIG. 3, upon startup, the variables are initialized (301) and memory allocated for set times and functions. Because display screens 4 are initially set to a start condition, timer control buttons 10a, 10b, 10c and 10d can be used to modify the timers, functions, etc., and

update the values displayed on display screens 4 (303). That is, if one of timer control buttons 10a, 10b, 10c or 10d are depressed (305), then the values being displayed on display screens 4 will be updated (303). Alternatively, player control buttons 8 may be used (307) to similarly update the active timer function and then update the display screens 4 (303) with the appropriate information. More specifically, one of player control buttons 8 is depressed to select the timer function (307). Then, one of player control buttons 8 may be depressed again (313) to update display screens 4 (31 1). Once display screens 4 are updated with the desired times, functions, etc., the users may play the game. Optionally at any time during play, one of timer control buttons 10a, 10b, 10c or 10d may be depressed (315) to update display screens 4 (319). If none of timer control buttons 10a, 10b, 10c or 10d are depressed, the game continues until completion. Upon completion of the game (317), display screens 4 are updated (319) and may again be set to the start condition, so that either a new game may be set or a previous game reset.

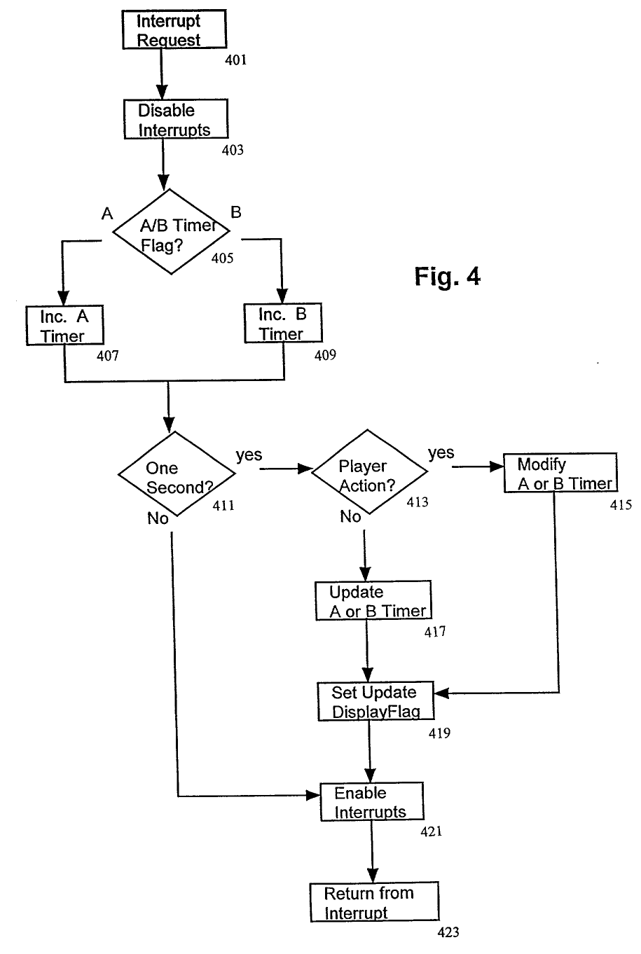

Turning next to FIG. 4, shown is a flow chart depicting a preferred embodiment of the timer software in accordance with a preferred embodiment of the present invention. Timer software may be an interrupt loop, triggered by timer overflow, allowing for a precise interval for timing control. Upon interrupt request (401), all other interrupts may be disabled (403) and ignored until such interrupt request (401) is serviced. The system first determines which timer “A” or “B” is to be modified by an active player A/B timer flag (405). The system will determine whether to increment A timer (407) or increment B timer (409). If the time unit has been reached (e.g., one second) (41 1), then the system will determine whether there is any player action (413). If so, the appropriate A or B timer will be modified (415), and a software flag will be set to update display screens 4 (419). If there is no player action, the appropriate A or B timer will be updated (417), and the timer values will be updated and a software flag will be set to update display screens 4 (419). Finally, all other interrupts are enabled (421), and the user(s) are returned (423), for example, to the game with the interrupt having been serviced.

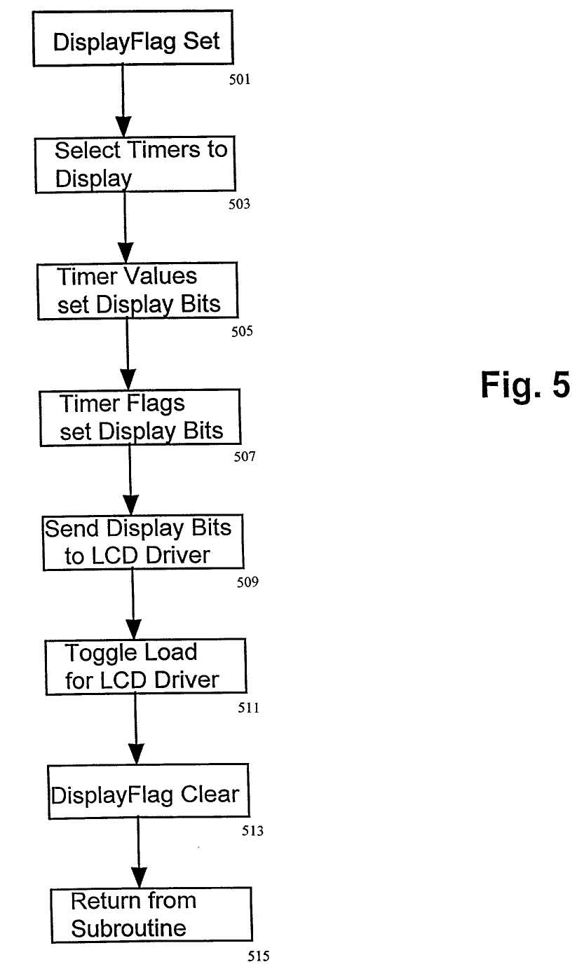

Next, referring to FIG. 5, depicted is a flow chart showing a preferred embodiment of the operation of display screens 4 according to a preferred embodiment of the digital game clock of the invention. The flow chart of FIG. 5 is intended to be an example of the overview of a subroutine for updating display screens 4. Accessed by other routines, or through software flags, this subroutine uses a value of a timer to update display screens 4. This may be done through the use of lookup tables or lists of display values. These lookup tables or lists of display values provide a bit pattern that may be strobed to display driver chip 8 through an output from microcontroller chip 18. As indicated above and as shown in FIG. 5, the system sets display flag to a start condition (501) and selects the appropriate timers to display (503). Timer values (505) and timer flags (507) are then used to set display bits, which are generally determined from tables. These display bits are then sent to display driver chip 8 (509) where the load is toggled (or strobed) (51 1) before the display flag is clear (513). Once this subroutine is finished, the system returns to the game timer operation (515).

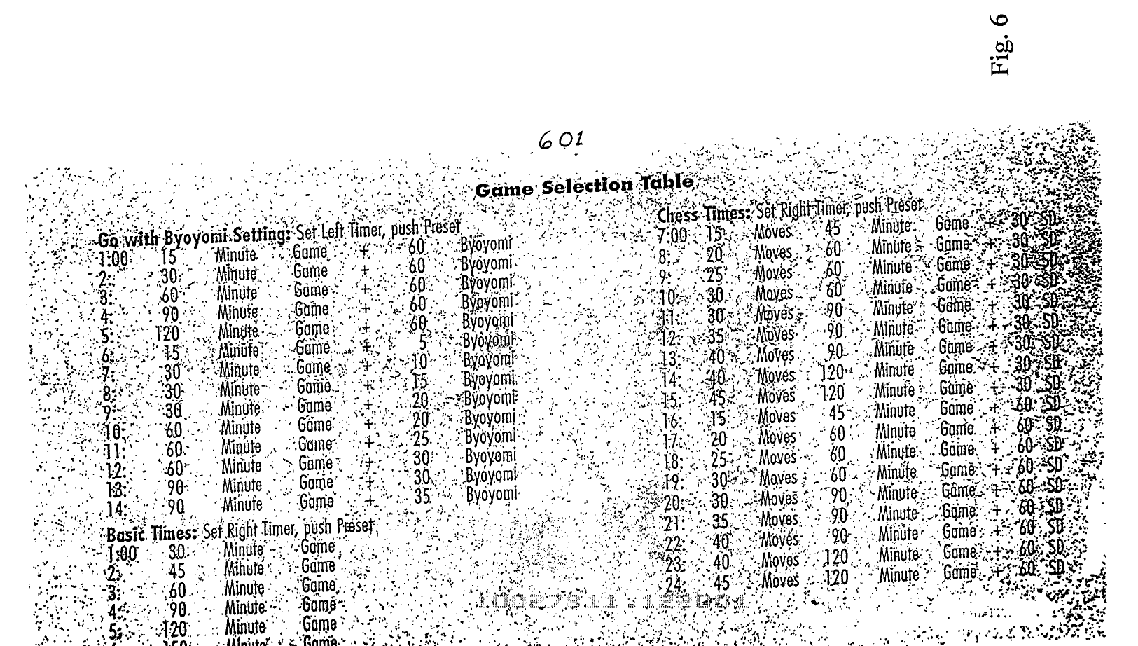

Turning lastly to FIG. 6, shown is Game Selection Table 601 that depicts certain preset times that may be programmed into the digital game clock of the present invention. Specifically, Table 601 provides various times for the games “Go with Byoyomi” and “Chess”, as well as some basic times. For example, using Table 601 as a reference guide, a user may wish to play Chess with a maximum of 45 moves and 120 minute periods with 30 minutes of sudden death play if the number of moves are used up. The user would (based on the programming represented in Table 601) hold “right timer” (i.e., timer control button 10d (see FIG. 2)), until “15:00” is displayed on a first one of display screens 4. Then, the user would push the “preset/reset” button (i.e., timer control button 10c). The above represents one example of how to select a timing option from a list of preset timing options as shown in Table 601. To start play, one of the players would then depress his/her respective player control button 8. This would in turn activate the appropriate timer. Of course, preset timing options are determined by the microcode embedded within microcontroller chip 18, and can be varied by varying the microcode.

The described embodiment represents the best mode of using and programming the multi-player digital game clock of the present invention. It is to be understood, especially by those skilled generally in the art of electronics and specifically in the art of timer electronics, that various modes of circuitry may be employed for carrying out the exemplary functions described above.

Furthermore, the programming for the digital game clock, as described above, can be varied substantially to provide alternative button sequences for certain operations and/or presets, as well as provide for numerous additional presets. This can be done at the point of assembly of the multi-player digital game clock, or the apparatus for programming or reprogramming the microcode of the microcontroller may be provided to the user with instructions regarding how to program or reprogram the microcontroller chip.

While the present invention has been described with reference to one or more preferred embodiments, such embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention. It should be appreciated that the present invention is capable of being embodied in other forms without departing from its essential characteristics.

What is claimed is:

1. A game clock for timing a plurality of gaming events, said game clock comprising:
a rigid housing;
an electronic timer for timing said plurality of gaming events;
a display means for displaying at least said timing;
a faceplate for protection of said electronic timer and said display means;
a plurality of control buttons for controlling a microcontroller for programming said game clock and for selecting a plurality of game timing options; and
a memory device embedded in a microcode of said microcontroller.

2. A game clock according to claim 1, wherein said game timing options are selected from a group consisting of single period play, multiple period play, recurrent time play, period with recurrent time and recurrent time with time allocation.

3. A game clock according to claim 1, wherein said game timing options include a plurality of timing options.

4. A game clock according to claim 3, wherein said timing options may include any of a plurality of a group consisting of predetermined length of total game time, predetermined timing interval for each player's turn, and predetermined initial time value.

5. An improved game clock according to claim 1, wherein said electronic timer counts down or up from an initial time value; wherein said counting is in predetermined time intervals.

6. A game clock according to claim 1, wherein said control button includes time control button for stopping said electronic timer.

7. A game clock according to claim 1, wherein said control button includes time control button for clearing said electronic timer.

8. A game clock according to claim 1, wherein said electronic timer counts down or up from an initial value in several selectable time unit increments for any timing interval.

9. A game clock according to claim 1, wherein said control buttons comprise a first player control button and a second player control button.

10. A game clock according to claim 11, wherein said player control buttons are switches coupled to said electronic timer and display means for activating or deactivating the incremental increase or decrease of the timing intervals, whereby the activation of the first player control button causes the second player control button to deactivate.

11. A game clock according to claim 1, wherein said electronic timer comprises an audible tone means for indicating the end of the time period.

12. A game clock for timing a plurality of gaming events, said game clock comprising:
a rigid solid housing;
an electronic timer for timing of a plurality of gaming events;
a display means for displaying at least said timing;
a faceplate for protection of said electronic timer and display means;
control buttons including first and second player control buttons;
a microcontroller for programming said game clock;
a memory device embedded in a microcode of said microcontroller;
wherein said memory device stores a multitude of game timing options; and
wherein said control buttons include a timer control button.

13. A game clock according to claim 12, wherein said game timing options are selected from a group consisting of single period play, multiple period play, recurrent time play, period with recurrent time and recurrent time with time allocation.

14. A game clock according to claim 12, wherein said game timing options include a plurality of timing options.

15. A game clock according to claim 14, wherein said timing options may include any of a plurality of a group consisting of predetermined length of total game time, predetermined timing interval for each player's turn, and predetermined initial time value.

16. An improved game clock according to claim 12, wherein said electronic timer counts down or up from an initial time value; wherein said counting is in predetermined time intervals.

17. A game clock according to claim 12, wherein said control button includes time control button for stopping said electronic timer.

18. A game clock according to claim 12, wherein said control button includes time control button for clearing said electronic timer.

19. A game clock according to claim 12, wherein said display means consists of a plurality of multi-function display devices capable of providing a readout of several said gaming options, including said timing options.

20. A game clock according to claim 12, wherein said player control buttons are switches coupled to said electronic timer and display means for activating or deactivating the incremental increase or decrease of the timing intervals, whereby the activation of the first player control button causes the second player control button to deactivate.

21. A game clock according to claim 12, wherein said electronic timer comprises an audible tone means for indicating the end of said time period.

22. A game clock for timing a plurality of gaming events, said game clock comprising:
a rigid housing;
an electronic timer for timing a plurality of gaming events;
display means for displaying at least said timing;
a faceplate for protection of said electronic timer and associated display;
a game selection table for indicating a plurality of gaming events;
control buttons for controlling a microcontroller for programming and selecting said gaming event;
memory means embedded a microcode of said microcontroller for storing said game selection table; and
wherein a player selects one of said gaming events to play a time-controlled game in accordance with said selected gaming event.

23. A game clock according to claim 26, wherein said game selection table includes a group of said gaming events consisting of chess, go and backgammon.

24. A game clock according to claim 26, wherein said game selection table specifies game timing options for said gaming events.

25. A game clock according to claim 26, wherein said game selection table specifies timing options for said gaming events.

26. A game clock according to claim 26, wherein said electronic timer comprises an audible tone means for indicating the end of said time period.

27. A game clock according to claim 12, wherein said player control buttons are switches coupled to said electronic timer and display means for activating or deactivating the incremental increase or decrease of the timing intervals, whereby the activation of the first player control button causes the second player control button to deactivate.

28. A game clock according to claim 26, wherein said display means consists of a plurality of multi-function display devices capable of providing a readout of several said time options and game options.

29. A game clock according to claim 26, wherein said electronic timer and display means comprises an audible tone means coupled to the timing displayed by the readout on the at least two multi-function display devices for indicating the end of the time period for each player for each event programmed.
